(19) United States
(12) Patent Application Publication
(10) Pub. No.: US 2007/0262477 A1
(43) Pub. Date: Nov. 15, 2007

(54) Volatile Liquid Dissemination Apparatus

(75) Inventors: Colin Brown, Berkshire (GB); Guy Edward Naish, Oxfordshire (GB)

Correspondence Address: NORRIS, MCLAUGHLIN & MARCUS, 875 THIRD AVE, 18TH FLOOR, NEW YORK, NY, 10022, US

(73) Assignee: GIVAUDAN SA, Vernier (CH)

(21) Appl. No.: 11/568,277

(22) PCT Filed: May 4, 2005
(86) PCT No.: PCT/CH05/00250

§ 371 Date: Nov. 20, 2006

(30) Foreign Application Priority Data
May 7, 2004 (GB) 0410194.5

(51) Int. Cl. B60H 3/00

(52) U.S. Cl. 261/19; 222/146.2

(57) ABSTRACT

An apparatus adapted to release individually into an atmosphere one of at least two volatile liquids, each liquid being in heat transfer contact with one face of a theromoelectric device, typically a Peltier device. The apparatus allows the emission of different liquids at different times.

This invention relates to apparatus for disseminating volatile liquids into an atmosphere, and more particularly to an apparatus comprising a plurality of such liquids and having the ability to disseminate selected liquids at selected times.

There are known in the art many apparatus for disseminating volatile liquids into an atmosphere. Such liquids include fragrances, insecticides, fungicides and medicaments. The dissemination of one of several liquids from the same apparatus is often desirable, for example, one of several different fragrances to change the “mood” in a room. However, this has not proved easy in practice, and previous apparatus have involved complex switching mechanisms and multiple diffusion methods. Such apparatus have not been completely successful and their acceptance has not been widespread.

It has now been found that it is possible to provide a simple, reliable apparatus that can disseminate one of a number of volatile liquids. The invention therefore provides an apparatus adapted to release individually into an atmosphere one of at least two volatile liquids, each liquid being in heat transfer contact with one face of a theromoelectric device.

The invention further provides a method of dissemination of a number of volatile liquids into an atmosphere, one or more at a time, comprising the placing of each liquid in heat transfer contact with one face of a thermoelectric device and causing that face to heat up and cause the liquid to evaporate, as desired.

Thermoelectric devices manifest the thermoelectric effect (sometimes called the Peltier-Seebeck effect), in which the passing of an electrical current causes one surface of the device to heat up and the other to cool down. The effect is used in, for example, small refrigerators, and the devices, sometimes called “Peltier devices” are readily available in a variety of sizes from commercial suppliers such as European Thermodynamics Ltd. (UK) and Ferrotec America Corp. (USA).

In the present invention, the volatile liquids are placed in heat transfer contact with the two faces of a thermoelectric device. By “heat transfer contact” is meant sufficiently good and extensive contact with the liquid, or with a container in which the liquid is held, such that heat can travel into or out of the liquid, causing it to heat up or cool down. Although it is possible to provide an apparatus in which the liquid contacts the thermoelectric device directly, the preferred way of achieving this is to place the liquid in a container which is both sufficiently heat conductive and sufficiently resistant to the liquid contained therein. The containers are typically made of vacuum-formed plastics materials, typically of polyethylene, polypropylene or a nitrile-based barrier resin such as Barex™ (ex BP Petrochemicals). For convenience further description of the invention will refer solely to this embodiment, although the invention is not in any way restricted thereto.

The container is shaped so as to contact the thermoelectric device or a heat-conductive surface attached thereto to a sufficient extent (in terms of both closeness of fit and area of contact) that heating will cause the liquid to vaporise and be released into an atmosphere. This contact can be achieved by any convenient means, one preferred means being the provision of shaped holders to accept removable containers, the holders being shaped such that the containers are held in heat transfer contact with the thermoelectric device or a surface attached thereto (typically a heat sink). It is thus easy to replenish or change liquids.

Preferably the liquids, preferably in containers as hereinabove described, on either side of the thermoelectric device are insulated from each other, so that heat transfer from the hot side of the thermoelectric device to the cool side is inhibited. Any suitable insulation may be used, for example, air, closed-cell foam or any material with poor thermal conductivity. The location of any such insulation will depend on the particular construction, but it is typically inserted between the containers themselves or any associated heat sinks.

Provided that the containers have appropriate heat transfer contact and are adapted to hold and release volatile liquids at appropriate times, their nature is not narrowly critical. In one embodiment, the container has the form of a flat, open tray and the liquid in liquid form is kept in place by a semi-permeable membrane placed over the open face of the tray. Alternatively, the liquid may be contained in a gel deposited in the tray; in such a case, no semi-permeable membrane would be necessary for retention. A further possibility is to include the liquid in a low melting point solid (of melting temperature of around 5°-35° C.), such that the solid would melt at the operating temperature to release volatile liquid, and then solidify to retain the liquid when the particular side of the thermoelectric device was cold.

The temperature range used in the apparatus may be any convenient temperature. This will vary with the nature of the liquid, and the skilled person will readily be able to choose an appropriate temperature. For example, in the case of a fragrance, 70° C. is generally adequate for the “hot” side. In the case of insecticides, higher temperatures may be needed, typically of up to 130° C. 0° C. is generally the minimum for the “cold” side, and preferably no lower than 2°-3° C. While it is possible to have lower temperatures, it is generally inadvisable, as lower temperatures could result in an undesirable build-up of condensation.

The electricity for causing the thermoelectric device to heat up or cool down is a direct current (DC) supply and it may come from any convenient source, for example, rectified mains electricity, batteries or solar cells. In addition, the electricity supply can be reversed or switched off, such that a side of the thermoelectric device can be caused to heat up or cool down, or both sides can come to ambient temperature, depending on the supply. Means for switching the direction of the electricity supply may be any convenient means. It may be manual, or it may be automatic. In the latter case, it may be equipped with timing means, such that certain liquids may be released at particular times only. In addition, safety devices can be built in, for example, devices that place upper or lower limits on the temperatures attainable. Such limits may be adjustable, to allow for different liquids.

The liquid may be disseminated by evaporation alone, or it may be assisted by forced ventilation, for example, from at least one fan.

In a further embodiment of the invention, an apparatus may comprise an array of containers, each pair with a thermoelectric device, all working from the same electricity supply and, where appropriate, the same switching mechanism.

The apparatus of the invention permits the easy, reliable, individual dissemination of a number of volatile liquids into an atmosphere. The invention therefore provides a method of dissemination of a number of volatile liquids into an atmosphere, one or more at a time, comprising the placing of each liquid in heat transfer contact with one face of a thermoelectric device and causing that face to heat up and cause the liquid to evaporate, as desired.

The invention is further described with reference to the accompanying drawings, which depict preferred embodiments and which are not meant to be in any way limiting.

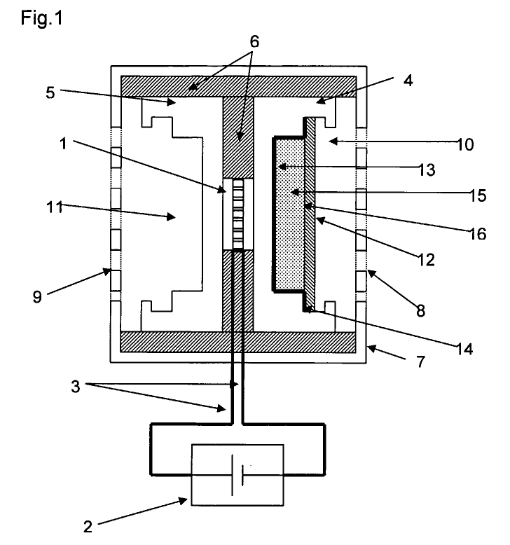

FIG. 1 is a schematic cross-section of an apparatus according to the invention.

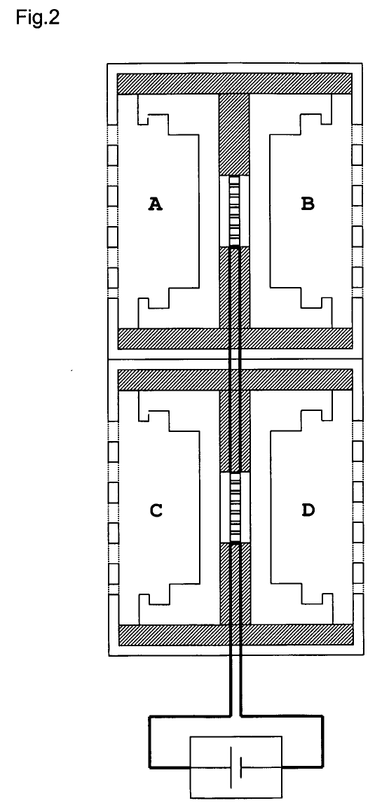

FIG. 2 is a schematic cross-section of another apparatus according to the invention.

In FIG. 1, a thermoelectric device 1 is supplied by electricity from a DC power source 2 via wires 3. The direction of current flow of this power source is reversible. On each side of the device and in heat transfer contact therewith is a heat sink, 4 and 5, these being insulated from each other by insulation 6. The device 1, heat sinks 4 and 5 and insulation 6 are housed within a rigid casing 7 with vents 8 and 9 on each side, to allow vapourised volatile liquid to escape.

Each heat sink is shaped to provide a cavity 10 and 11. Into this cavity fits a volatile liquid container 12. In FIG. 1, for the purposes of illustration, only one cavity 10 is shown as having a container generally indicated as 12—normally cavity 11 would also have a container. The container 12 comprises a tray 13 with a surrounding flange 14, adapted to fit tightly into the cavity 10. Within the tray is a volatile liquid 15, retained therein by a semi-permeable membrane 16.

In operation, when current passes from the power source 2 to the thermoelectric device 1, one side of the device will heat up and the other will cool down, the heat from the heated side passing into the heat sink. In the case where the heat sink 4 is heated, the container 12 is heated and the liquid vapourises, passing through the semi-permeable membrane 16 and into the atmosphere via the vent 8. Reversal of the current flow will cause heat sink 5 to heat up.

FIG. 2 depicts an apparatus with the capacity for four volatile liquids in two modules each of two cavities, here labelled A, B, C and D. Given that each module can be on or off, and that when on, the two sides are either hot or cold, this means that there are eight possibilities. If there were three modules, the number of possibilities increases to 26.

1. An apparatus adapted to release individually into an atmosphere one of at least two volatile liquids, each liquid being in heat transfer contact with one face of a theromoelectric device.

2. An apparatus according to claim 1, in which the thermoelectric device is a Peltier device.

3. An apparatus according to claim 1, in which the liquid in placed in a container, which is both sufficiently heat conductive and sufficiently resistant to the liquid contained therein.

4. An apparatus according to claim 3, in which the container has the form of a flat, open tray and the liquid is selected from the following:
(a) a liquid in liquid form, being kept in place by a semi-permeable membrane placed over the open face of the tray;
(b) the liquid contained in a gel deposited in the tray; and
(c) the liquid included in a low melting point solid, such that the solid melts at the operating temperature to release volatile liquid, and then solidifies to retain the liquid when the particular side of the thermoelectric device is cold.

5. An apparatus according to claim 1, in which the liquids on either side of the thermoelectric device are insulated from each other, so that heat transfer from the hot side of the thermoelectric device to the cool side is inhibited.

6. An apparatus according to claim 1, comprising an array of pairs of containers, each pair with a thermoelectric device, all working from the same electricity supply.

7. An apparatus according to claim 6, in which the pairs of containers share a common switching mechanism.

8. A method of disseminating a number of volatile liquids into an atmosphere, one or more at a time, comprising the placing of each liquid in heat transfer contact with one face of a thermoelectric device and causing that face to heat up and cause the liquid to evaporate, as desired.
